(19) United States
(12) Patent Application Publication
(10) Pub. No.: US 2004/0117217 A1
(43) Pub. Date: Jun. 17, 2004

(54) Financial incentive through insurance offerings for vehicles that utilize a safety system

(76) Inventors: Richard R. Reber, Lubbock, TX (US); Cary A. McGregor, Austin, TX (US)

Correspondence Address: TOLER & LARSON & ABEL L.L.P., 5000 PLAZA ON THE LAKE STE 265, AUSTIN, TX, 78746, US

(21) Appl. No.: 10/321,761

(22) Filed: Dec. 17, 2002

(51) Int. Cl. G06F 17/60; G05D 1/00; G05D 3/00; G06F 7/00; E05F 15/00; B60Q 1/00; B60R 22/04

(52) U.S. Cl. 705/4; 340/457.1; 280/802; 701/45

(57) ABSTRACT

The present disclosure relates generally to safety systems and related insurance offerings to encourage increased use of passenger restraint safety devices, such as seat belts. In a particular embodiment, a method to encourage use of a passenger restraint device in a vehicle that relates to a financial incentive and an insurance offering is disclosed.

### FIELD OF THE DISCLOSURE

The present invention relates generally to financial incentives through insurance offerings for vehicles that utilize a safety system

### BACKGROUND

In spite of numerous laws, government enforcement efforts, and a great deal of public education regarding seat belt use, seat belts are still not being used to the fullest extent desirable within the United States. The result is great and needless loss of life and preventable injuries. One problem associated with seat belt non-use is based at least in part on human behavior issues. An example of a behavioral problem is seen from traffic accident data that reveals that a disproportionately high number of deaths of younger occupants, e.g. occupants having the ages of 16-22, result from the absence of seat belt use. This class of young occupants needs encouragement to change their behavior and to voluntarily buckle up.

Accordingly, there is a need for an improved system and method to encourage seat belt use, especially for younger occupants.

### SUMMARY

The present invention relates generally to safety systems and related insurance offerings to encourage increased use of passenger restraint safety devices, such as seat belts. In a particular embodiment, a method to encourage use of a passenger restraint device in a vehicle is disclosed. The method includes offering insurance having an associated financial incentive based on installation of a safety system. The method further includes installing the safety system into the vehicle. The safety system comprises at least one occupant detector, at least one passenger restraint device use detector responsive to the at least one occupant detector, a controller responsive to the at least one occupant detector, and the at least one passenger restraint device use detector, and a vehicle activation device to take an action having an effect on an occupant of the vehicle. The at least one passenger restraint device use detector is to determine use by the passenger of the passenger restraint device attached to the seat within the vehicle.

In another embodiment, the method includes offering insurance that includes a financial incentive based on the presence of the safety system within the vehicle.

In another embodiment, a method to analyze usage of a passenger restraint device in a plurality of vehicles is disclosed. The method includes installing a safety system in a plurality of vehicles, collecting and storing passenger restraint device use data for each of the plurality of different vehicles, and analyzing the passenger restraint device use data.

### BRIEF DESCRIPTION OF THE DRAWINGS

FIG. 1 is a block diagram of an illustrative safety system.

FIG. 2 is a general diagram that further illustrates a portion of the safety system of FIG. 1.

FIG. 3 is a flow chart that illustrates a method of offering insurance products that relate to installing a safety system into a vehicle.

FIG. 4 is a flow chart that illustrates another method of offering insurance products related to vehicles having a pre-installed safety system.

The use of the same reference symbols in different drawings indicates similar or identical items

### DETAILED DESCRIPTION OF THE FIGURES

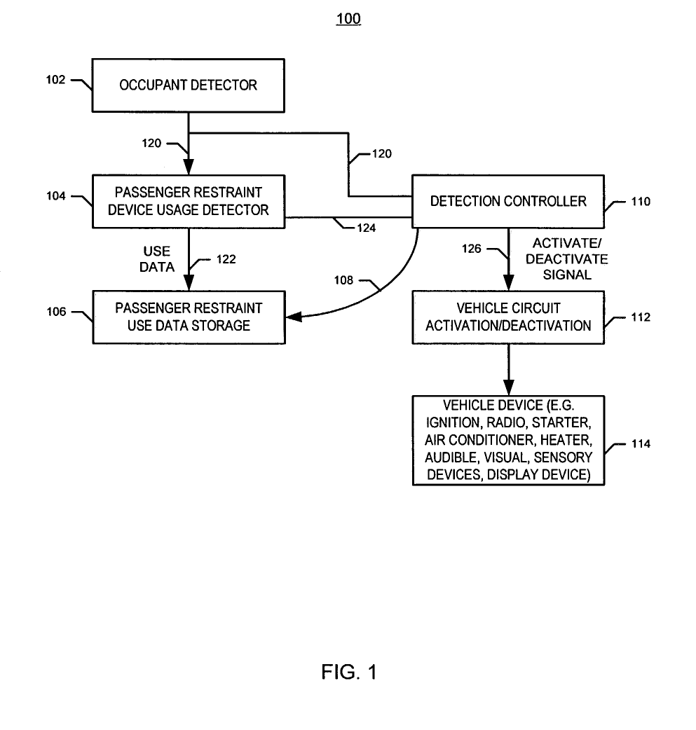

Referring to FIG. 1, an illustrative safety system 100 is shown. The safety system 100 includes an occupant detector 102, a passenger restraint device usage detector 104, a controller 110, and a vehicle circuit activation/deactivation unit 112. The system 100 further includes passenger restraint use data storage 106 that receives usage data 122 from the passenger restraint device usage detector 104. The controller 110 is coupled to the data storage 106 via a control signal 108. The system 100 also interfaces with a vehicle device 114, such as a vehicle ignition, radio, starter, air conditioner, heater, audible device, visual device, sensory device, and display device. While the vehicle device 114 is illustrated in FIG. 1 along with the safety system 100, it should be understood that the vehicle device 114 is a separate component that is present within a vehicle, such as a passenger car or truck, and may be provided and installed separately from the safety system 100.

The occupant detector 102 is used to determine when an occupant is detected in a seat in the vehicle. The occupant detector 102 for a driver may be an ignition detector, odometer detector, drive selector, or other vehicle use detector. The passenger restraint device usage detector 104 is used to determine whether a detected passenger has activated their passenger restraint device, such as by fastening their seat belt. The passenger restraint device usage detector 104 is responsive to the occupant detector 102 and receives an indicator of passenger occupancy via signal 120. The controller 110 is responsive to the occupant detector 102 and is also responsive to the passenger restraint device usage detector 104. The controller 110 receives the signal 120 indicating passenger detection and receives an indication of whether the passenger has used the restraint device via input 124.

The controller 110 also may output an activate/deactive signal 126 to the vehicle circuit activation and deactivation unit 112. In this case, the vehicle circuit activation and deactivation unit 112 may cause internal vehicle elements, such as the ignition, the radio, the air-conditioning, heater, various sensory devices, or other vehicle components to be activated or deactivated.

The circuit unit 112 may also activate an audio buzzer, ding dong or start a recording (which may be continuous, intermittent, louder as the vehicle goes faster or the longer some one is unbuckled, or other patterns to encourage seat belt use). Also, a visual element, such as a series of lights may be activated to alert or remind the occupant. The alert can be instantaneous, delayed, intermittent, continuous, progressively shorter, longer, louder, brighter, etc, and can range from immediate activation or deactivation of a circuit or the action may be run through a delay circuit. The circuit may activate a perfumer, a vibrator or anything that could potentially bring about the behavior of seat belt use that can be achieved by some sensory mechanism.

The controller 110 may, in some configurations, provide a warning indicator to a vehicle element 114 that is a display device. An example of a warning indicator would be a light or audio alarm that is relayed by the display device. The display device may be a console installed within the vehicle such as in the front passenger compartment dashboard of the vehicle. The display device may include conventional display indicators such as light emitting diodes (LED)s. An example use of the display device is where a vehicle occupant, such as a parent, views a seat belt non-use warning, such as where a rear seat passenger (e.g. a child) has not buckled up. In this scenario, the vehicle driver (i.e. the parent) can then instruct the rear seat passenger to buckle up before starting the vehicle, or in the event the child unbuckles while the vehicle is in use.

The detection controller 110 would issue the activate/deactive signal 126 when the controller 110 has determined passenger occupancy and has detected a non-use condition of the passenger restraint device. The safety system 100 may be installed in a vehicle and provides either encouragement, such as through visual display signals, or inactivation of the vehicle, such as through circuit deactivation of the ignition or vehicle starter, to encourage seat belt use.

In addition, passenger restraint device usage data may be collected by data storage unit 106. The collection, storage, and monitoring of actual passenger restraint device use also may provide safety encouragement to occupants of the vehicle. For example, a teenage occupant of a vehicle owned by a parent may be encouraged to use their seat belt if the teenage occupant knows that the parent can monitor the actual seat belt use by the teenager. The data storage unit 106 is coupled to the detection controller 110 via control signal 108.

The passenger restraint device use data and other data produced by use of the safety system 100 may also be remotely collected, stored, and analyzed for many different vehicles. A wireless communication device may be used to provide the remote communication from the vehicles to a data storage center. One use of such data aggregation and analysis is to identify and improve the safety system based on real-world usage data. Another benefit is the ability to study human behavior, including testing on different classes of passengers/occupants. One method of testing different classes of occupants is to create different sets of users, such as based on demographic profiles, and to test seat belt use for the different sets of users with the same configuration and with different configurations of the safety system 100.

For example, the safety system may be installed in different behavioral group vehicles and the seat belt usage data may be collected. Different study groups would have different implementations of the device activated. Some may only have a display unit. Some may have display unit and radio interlock. Some may have a display unit and air conditioner deactivated until everyone buckles back up. Some may have the air conditioner set up to be activated but it turns off for a period of time and then back on so that it effectively “cycles” which may be the nuisance to encourage buckling up. In this manner the data can then be loaded into databases and studied and analyzed to determine the “optimum” configurations for different “groups” which may be gender, age, cultural and other profile groups. The data may be used to indicate the effectiveness of the device in various configurations to encourage seat belt use behavior. The data may also be used to adjust the financial incentive.

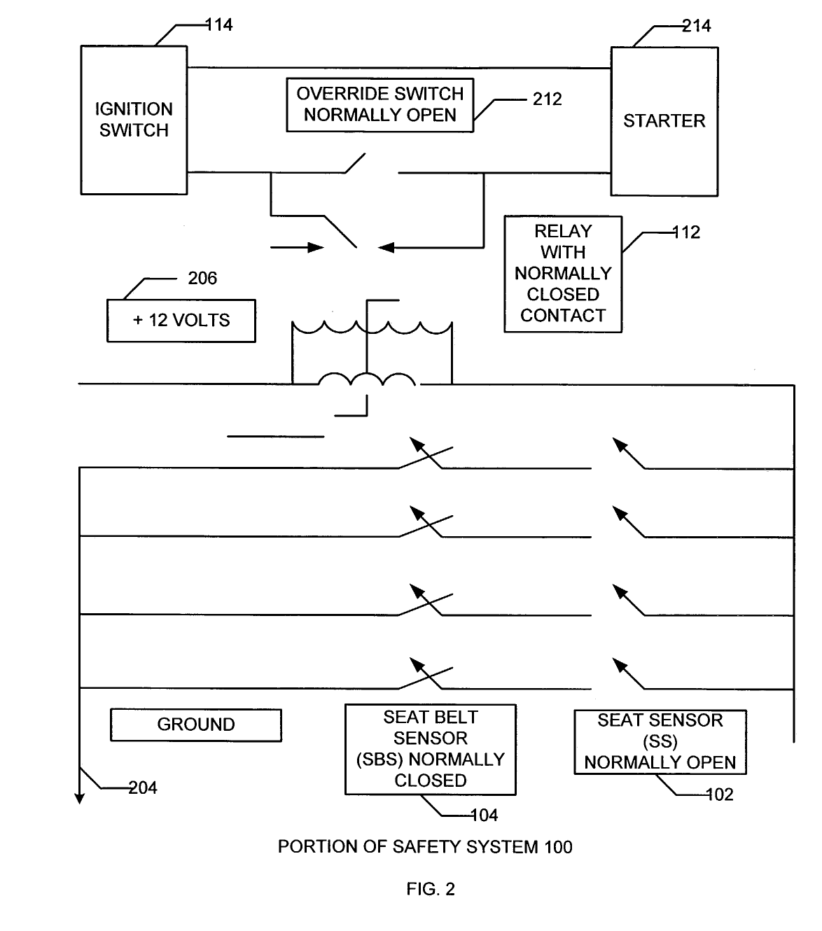

Referring to FIG. 2, a further detailed illustration of a portion of the safety system 100 is disclosed. The safety system 100 includes the occupant detector 102, such as the seat sensor illustrated. An example of the passenger restraint device usage detector 104 is a seat belt sensor as shown. In the specific example illustrated in FIG. 2, the seat sensor 102 and the seat belt sensor 104 are coupled in series between a power supply 206 and ground 204. In addition, an example of a vehicle circuit activation/deactivation unit is relay 112.

During operation, the relay 112, which is normally closed, allows power to flow from the ignition switch 114 to the starter 214 without obstruction as long as the relay 112 is not activated. The override switch 212 is normally open, which allows the relay 112 to function normally. In an emergency situation, the override switch 212 may be used to prevent operation of the safety system elements so that the vehicle may be started without interference. When an occupant enters the vehicle and activates the seat sensor 102 by sitting in the seat, current flows from the battery 206 through the relay coil 112, through the seat sensor 102, and through the seat belt sensor 104 to ground 204. This condition causes the relay 112 to open so that the starter 214 will not be activated. When the occupant closes the seat belt, the seat belt sensor 104 opens so that current does not flow through the relay coil 112, resulting in the ignition switch 114 being allowed to operate the starter 214. Each seat within the vehicle may be equipped with a seat sensor 102 and a seat belt sensor 104. In this particular example, the safety system feature would prevent the vehicle from starting until all occupants have completely fastened their seat belts. While a detailed circuit has been disclosed by way of example, it should be understood that the safety system may be implemented in a variety of other ways including combined hardware and software implementations.

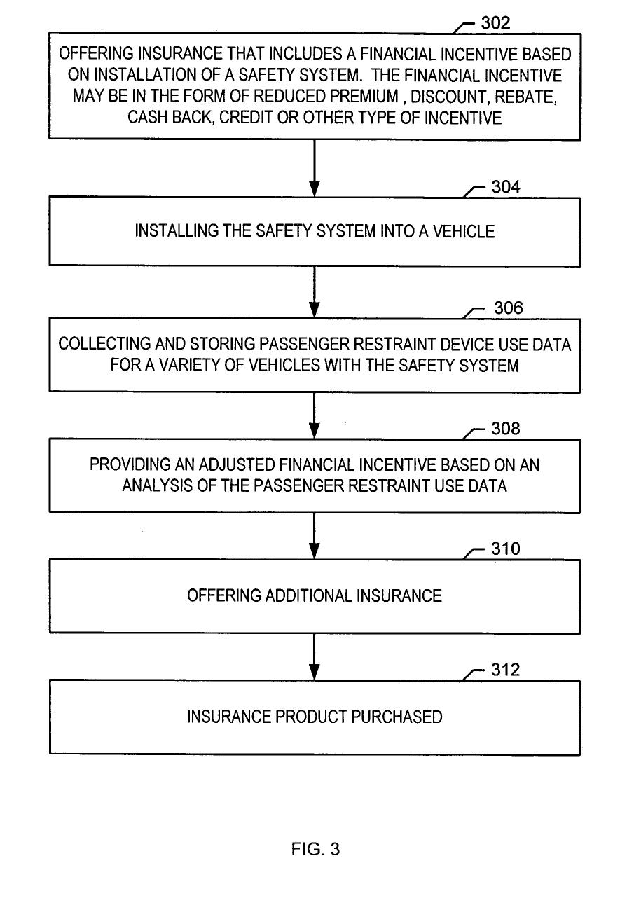

Referring to FIG. 3, a method of encouraging seat belt use is illustrated. The method includes a step of offering an insurance product. The insurance product offered includes a financial incentive based on installation of the safety system. Insurance may be offered to parents of teenage occupants as a particular example. Parents of teenage occupants typically have high vehicle insurance rates and would likely desire a reduced insurance rate. In addition, many parents of teenage occupants value seat belt use and would be willing to encourage seat belt use by using a safety system. The step of offering insurance is shown, at 302. The method includes a step of installing a safety system into a vehicle, at 304. An example safety system has been illustrated with respect to FIGS. 1 and 2. Passenger restraint device usage data is collected and stored for one or more vehicles having the safety system installed, at 306. An adjusted financial incentive may be provided where such financial incentive is based on an analysis of the collected passenger restraint usage data, at 308. Claims experience may also be used to determine the adjusted financial incentive. Insurance, other then vehicle insurance, may be offered, at 310. An example of such non-vehicle insurance includes homeowner's insurance, life insurance and health insurance. Finally, the insurance product(s) may be purchased as shown at 312.

A benefit of having the ability to offer financial incentives for use of the safety system is the ability to offer insurance with a financial incentive to encourage seat belt use. Such insurance may be offered as a package for customer convenience and to reduce sales/marketing costs for the insurance company leading to increased customer value and insurance company profitability. In addition, due to the expected increase in seat belt use after installation of the safety system, the expected cost to provide insurance is reduced. In addition to saving lives and reducing disabling injuries, the safety system reduces the expected costs of insurance such as vehicle, health, life insurance, disability insurance, liability or other insurance that is related to reduction in hospitalization, vehicular accident injuries, or related costs..

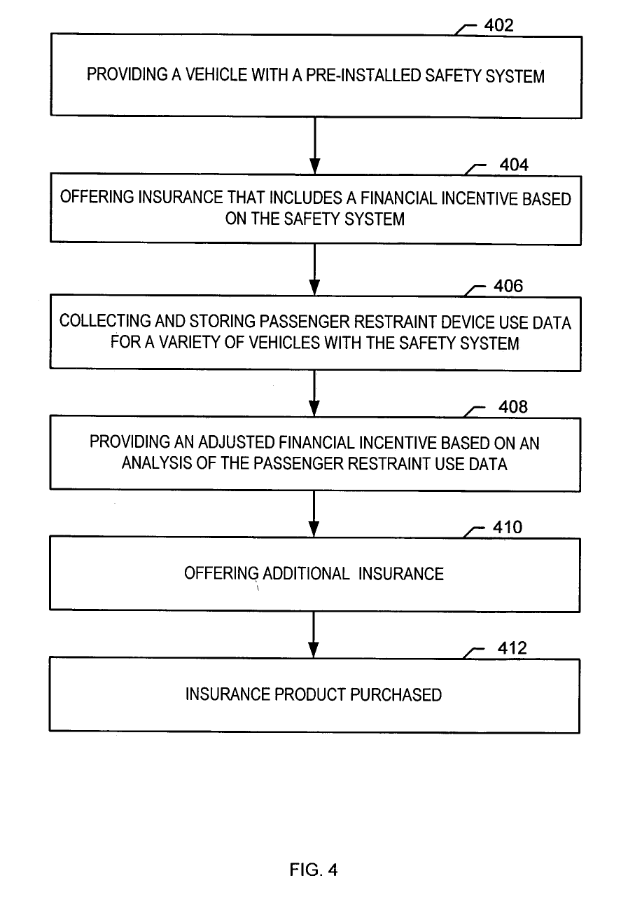

Referring to FIG. 4, a method of providing insurance for vehicles already having a pre-installed safety system is illustrated. The method includes a first step of providing the vehicle having the pre-installed safety system, at 402. The pre-installed safety system may be embedded within a new vehicle where the original equipment manufacturer (OEM) has installed the safety system device. Another example is where such safety system is an option that is loaded onto the device at the dealership. Next, at 404, an insurance product is offered. The insurance product includes a financial incentive or otherwise has a reduced rate that is based on the safety system. The insurance product may be offered to a subset of the population having a particular demographic profile, such as young or teenage occupants.

In an alternate embodiment, passenger restraint device usage data may optionally be collected and stored for one or more vehicles having the safety system installed, at 406. An adjusted financial incentive may be provided where such financial incentive is based on an analysis of the collected passenger restraint usage data, at 408. Additional insurance may be offered, at 410. An example of such insurance includes homeowner's insurance, life insurance, health insurance, disability, or other insurance related to reductions in vehicle accident costs. Finally, an insurance product or products may be purchased as shown, at 412.

The above disclosed subject matter is to be considered illustrative, and not restrictive, and the appended claims are intended to cover all such modifications, enhancements, and other embodiments which fall within the true spirit and scope of the present invention. For example, while certain applications have been discussed for the target market of teenage occupants, the insurance offerings and system disclosed are suitable and may be used by any occupants. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method to encourage use of a passenger restraint device in a vehicle, the method comprising:
offering insurance, the insurance offered having an associated financial incentive based on installation of a safety system;
installing the safety system into the vehicle, the safety system comprising:
at least one occupant detector;
at least one passenger restraint device use detector responsive to the at least one occupant detector, the at least one passenger restraint device use detector to determine use of the passenger restraint device attached to the seat within the vehicle;
a controller responsive to the at least one occupant detector and the at least one passenger restraint device use detector; and
a vehicle activation device to take an action having an effect on an occupant of the vehicle.

2. The method of claim 1, wherein the occupant detector is to determine the presence of an occupant in a seat within the vehicle and wherein the vehicle activation device further comprises a circuit deactivation unit, the circuit deactivation unit to disable at least one vehicle device.

3. The method of claim 1, wherein the action is taken to activate at least one vehicle device selected from the group consisting of vehicle ignition, car radio, air-conditioning, a heater, an audio device, a visual device, a sensory device, an alert, and a seat belt use recordation device.

4. The method of claim 1, wherein the safety system further comprises a display device, the display device coupled to the controller, the display device having an indicator responsive to detection of an occupant by the occupant detector and detection of non-use of the passenger restraint device by the occupant, wherein the safety system includes a plurality of occupant detectors and a plurality of passenger restraint device use detectors, and wherein the controller comprises a relay circuit.

5. The method of claim 1, wherein the insurance financial incentive includes a plurality of financial incentive levels, a first of the financial incentive levels based on a first configuration of the safety system that requires vehicle ignition lock-out and a second of the plurality of financial incentive levels based on a second configuration of the safety system that provides a warning display but does not provide ignition lock-out, the first financial incentive level providing a greater financial incentive then the second financial incentive level.

6. The method of claim 1, wherein an insured passenger of the vehicle is a teenage occupant and wherein the insurance policy is offered to a parent of the insured passenger.

7. The method of claim 6, further comprising offering a second type of insurance policy to the parent.

8. The method of claim 1, wherein the insurance is selected from the group consisting of home-owners insurance, life insurance, disability, liability, and health insurance.

9. The method of claim 1, further comprising collecting and storing passenger restraint device use data for a plurality of different vehicles that each have the safety system installed.

10. The method of claim 9, further comprising adjusting the financial incentive for the insurance policy based on the use data collected.

11. A method to encourage use of a passenger restraint device in a vehicle, the method comprising:
offering insurance, the insurance including a financial incentive based on the presence of
a safety system within the vehicle, the safety system comprising:
at least one occupant detector;
at least one passenger restraint device use detector responsive to the at least one occupant detector, the at least one passenger restraint device use detector to determine use of the passenger restraint device attached to the seat within the vehicle;
a controller responsive to the at least one occupant detector and the at least one passenger restraint device use detector; and
a vehicle activation device to take an action having a sensed effect on an occupant of the vehicle.

12. The method of claim 11, wherein the safety system further includes a data storage unit to collect and store usage data responsive to use of the passenger restraint device.

13. The method of claim 11, wherein the passenger restraint device is a seat belt and wherein the occupant detector determines the presence of an occupant, the occupant detector selected from the group consisting of an ignition detector, an odometer detector, a drive selector detector, and a vehicle use detector.

14. The method of claim 11, wherein the safety system further comprises a display device, the display device coupled to the controller, the display device having an indicator responsive to detection of an occupant by the occupant detector and detection of non-use of the passenger restraint device.

15. The method of claim 11, further comprising collecting, storing, and analyzing use data associated with vehicle operation using the safety system.

16. A method to analyze use of a passenger restraint device in a plurality of vehicles, the method comprising:
installing a safety system in a plurality of vehicles, the safety system comprising:
at least one occupant detector to determine the presence of an occupant in a seat within the vehicle;
at least one passenger restraint device use detector responsive to the at least one occupant detector, the at least one passenger restraint device use detector to determine use by the passenger of the passenger restraint device attached to the seat within the vehicle;
a controller responsive to the at least one occupant detector and the at least one passenger restraint device use detector; and
a circuit activation/deactivation unit, the circuit activation/deactivation unit to control a vehicle device;
collecting and storing passenger restraint device use data for each of the plurality of different vehicles; and
analyzing the passenger restraint device use data.

17. The method of claim 16, wherein the vehicle device is selected from the group consisting of vehicle ignition, car radio, air-conditioning, a heater, an audio device, a visual device, a sensory device, an alert, and a seat belt use recordation device.

18. The method of claim 17, further comprising testing a first set of vehicles where the safety system has a first configuration of selected vehicle devices and testing a second set of vehicles where the safety system has a second configuration of selected vehicle devices.

19. The method of claim 18, wherein a first set of occupants use the first set of vehicles and a second set of occupants use the second set of vehicles.

20. The method of claim 19, wherein the first set of occupants and the second set of occupants are selected based on a demographic profile.

21. The method of claim 16, further comprising marketing the passenger restraint device use data.
